(19) United States
(12) Patent Application Publication
(10) Pub. No.: US 2020/0334634 A1
(43) Pub. Date: Oct. 22, 2020

(54) System and Method for Generating a Pick Wave Sequence

(71) Applicant: System Logistics Corporation, Arden, NC (US)

(72) Inventor: Stephen Flynn, Forest City, NC (US)

(73) Assignee: System Logistics Corporation, Arden, NC (US)

(21) Appl. No.: 16/853,041

(22) Filed: Apr. 20, 2020

Related U.S. Application Data
(60) Provisional application No. 62/835,840, filed on Apr. 18, 2019.

(51) Int. Cl. G06Q 10/08

(52) U.S. Cl. CPC G06Q 10/0875

(57) ABSTRACT

A system for generating a pick wave sequence includes a conveyor system having a sorting apparatus, the sorting apparatus including a plurality of zones, each of the plurality of zones defining one of a plurality of input locations or output locations; a computing system including one or more processors; and a database coupled to the one or more processors and storing program instructions that are executed by the one or more processors upon receipt of a user input defining a delivery sequence list and an item location list causing the one or more processors to at least determine, based at least in part on the sorting apparatus configuration and the user input, a pick wave sequence list.

### RELATED APPLICATION

This application claims the benefit of U.S. Provisional Patent Application Ser. No. 62/835,840 filed on Apr. 18, 2019.

### FIELD OF THE INVENTION

This invention relates to pick wave sequencing and, more particularly, a system and method for generating a pick wave sequence for a user.

### BACKGROUND OF THE INVENTION

In the warehouse and distribution industry, various methods of picking items to customer orders exist. The most basic of these methods is discrete picking, where the order picker must travel to the location where each of the items are stored and pick the quantity associated with the order. The wave picking method involves picking items in an order that are stored in a selected pick zone, decreasing the amount of travel time taken to pick each of the items. Batch picking involves picking items from a single location that may belong to multiple customer orders, minimizing repetitive visits to the same pick location.

With the inception of automation into the warehouse and distribution industry, a level of intelligence has been added to facilitate both accuracy and efficiency of the order picking process. However, some elements of the automation may require the use of one or more of the aforementioned picking methods. The use of these picking methods in conjunction with automation presents several inefficiencies consistent with existing inefficiencies in manual order picking operations.

Accordingly, there exists a need for a system and method for generating a pick wave sequence utilizing an in-memory simulator for extracting an ordered set of conveyable items to be delivered to a conveyance mechanism having the ability to organize items into a usable linear delivery sequence.

### SUMMARY OF THE INVENTION

In accordance with one form of the present invention, there is provided a computer-implemented method, including, under control of one or more computing systems configured with executable instructions, receiving a user input being defined as a delivery sequence list and an item location list; detecting, with a conveyor system including a sorting apparatus, the sorting apparatus including a plurality of zones, each of the plurality of zones defining one of a plurality of input locations or output locations, a sorting apparatus configuration; determining, based at least in part on the sorting apparatus configuration and the user input, a pick wave sequence list including a plurality of item information; in response to determining the pick wave sequence list, sending for presentation to a user, first item information, wherein the first item information includes a representation of a first item determined to be associated with the user input for picking; determining that the user has placed the picked item on one of the plurality of input locations of the sorting apparatus; positioning the first item on one of the input and output locations of the plurality of zones in accordance with the delivery sequence list; sending for presentation to a user, subsequent item information, wherein the subsequent item information includes a representation of a subsequent item determined to be associated with the user input for picking; determining that the user has placed the picked item on one of the plurality of input locations of the sorting apparatus; and positioning the subsequent item on one of the input and output locations of the plurality of zones in accordance with the delivery sequence list.

In accordance with another form of the present invention, there is provided a computer-implemented method, including, under control of one or more computing systems configured with executable instructions, receiving a user input; detecting, with a conveyor system including a sorting apparatus, the sorting apparatus including a plurality of zones, each of the plurality of zones defining one of a plurality of input locations or output locations, a sorting apparatus configuration; determining, based at least in part on the sorting apparatus configuration and the user input, a pick wave sequence list including a plurality of item information; in response to determining the pick wave sequence list, sending for presentation to a user, first item information, wherein the first item information includes a representation of a first item determined to be associated with the user input for picking; determining that the user has placed the picked item on one of the plurality of input locations of the sorting apparatus; positioning the first item on one of the input and output locations of the plurality of zones in accordance with the delivery sequence list; sending for presentation to a user, subsequent item information, wherein the subsequent item information includes a representation of a subsequent item determined to be associated with the user input for picking; determining that the user has placed the picked item on one of the plurality of input locations of the sorting apparatus; and positioning the subsequent item on one of the input and output locations of the plurality of zones in accordance with the delivery sequence list.

In accordance with another form of the present invention, there is provided a pick wave sequence system having a conveyor system including a sorting apparatus, the sorting apparatus including a plurality of zones, each of the plurality of zones defining one of a plurality of input locations or output locations; a computing system including one or more processors; and a database coupled to the one or more processors and storing program instructions that are executed by the one or more processors upon receipt of a user input defining a delivery sequence list and an item location list causing the one or more processors to at least determine, based at least in part on the sorting apparatus configuration and the user input, a pick wave sequence list.

### BRIEF DESCRIPTION OF THE DRAWINGS

For a fuller understanding of the nature of the present invention, reference should be made to the following detailed description, taken in conjunction with the accompanying drawings in which:

FIG. 1 is a schematic illustrating the relationship between a conveyor system, a database and associated computer system;

FIG. 2 is a perspective view of a sorting apparatus, which is a part of the conveyor system;

FIG. 3 is a flow diagram illustrating the pick wave generation as part of the automated picking process;

FIG. 4 is a schematic illustrating one example of the method and apparatus of the present invention; and

FIG. 5 is a schematic illustrating one example of the method and apparatus of the present invention.

Like reference numerals refer to like parts throughout the several views of the drawings.

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF THE PREFERRED EMBODIMENTS

Referring to the several views of the drawings, the system for generating a pick wave sequence for a user is shown and described herein and is generally indicated as 100. The disclosed system 100, including associated sorting apparatus 200, generally promotes speed and efficiency by consolidating the advantages of discrete, wave, and batch picking methods without the negative consequences frequently associated with each method.

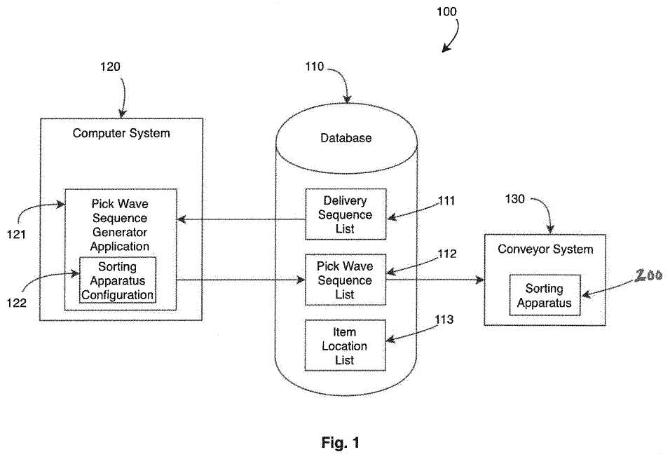

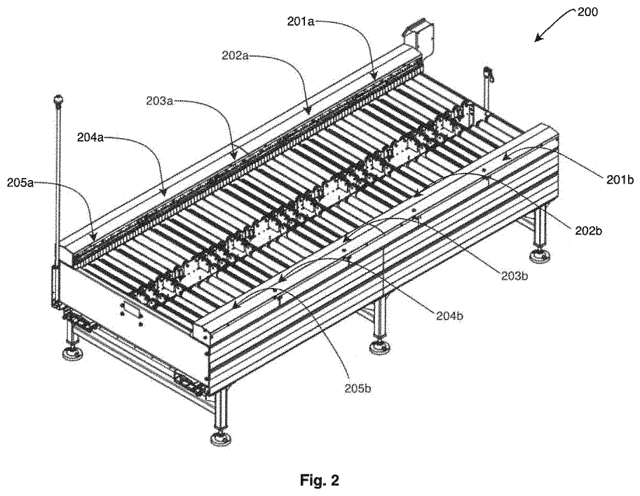

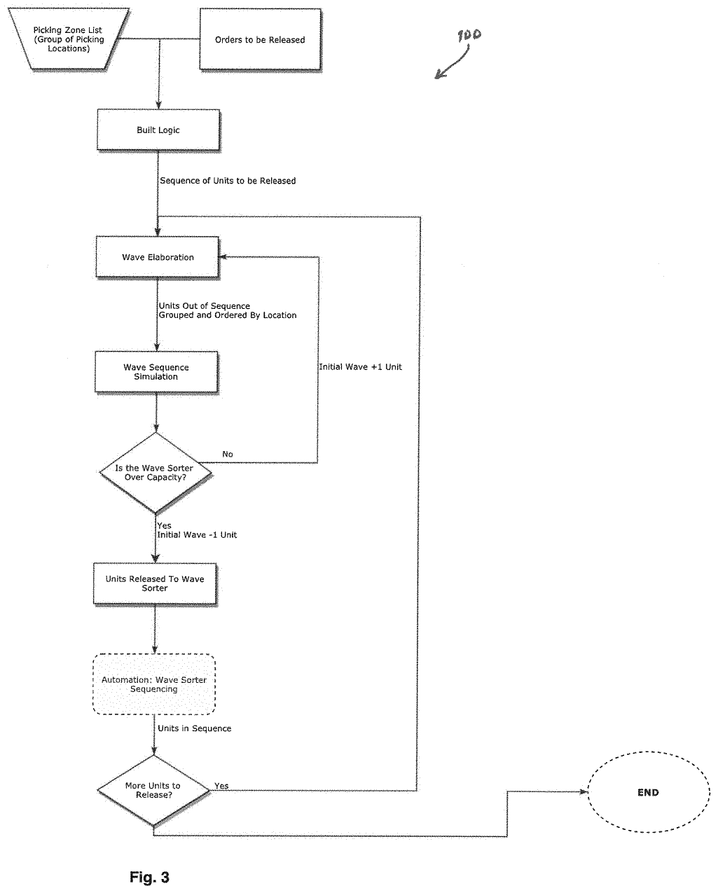

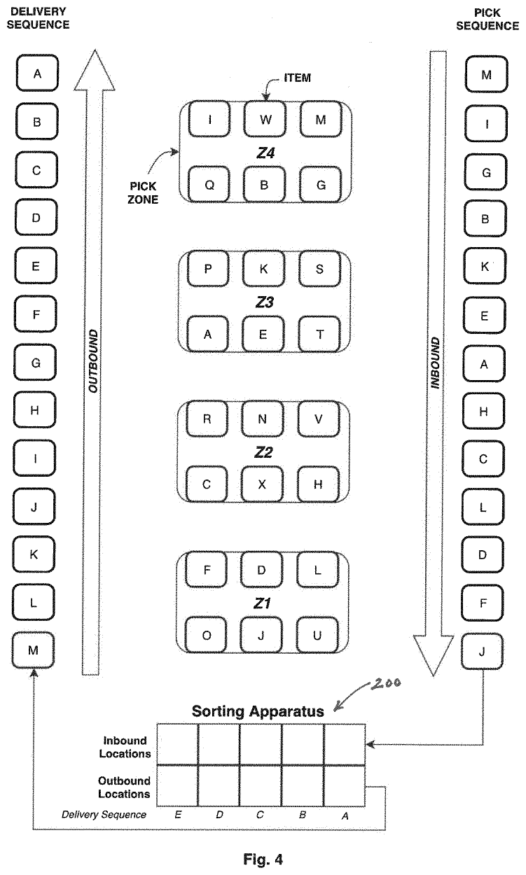

Referring initially to FIGS. 1-4, an automated pick wave sequence generator system 100 is disclosed. In one embodiment, item locations are grouped into pick zones, e.g., Z1, Z2, Z3, Z4, and identified in an ascending order beginning with the pick zone closest in proximation to the sorting apparatus 200 (see FIG. 4) of the overall conveyor system 130. A database 110 is communication with a computer system 120 is configured for the user to provide the delivery sequence list 111.

A computer system 120 includes a pick wave sequence generator program 121 structured and disposed to receive a first input defining an item location list 113 to be used for pick wave generation. The pick wave sequence generator program 121 is further structured and disposed to receive a second input defining the sorting apparatus configuration 122, including a plurality of zones 201A, 201B, 202A, 202B, 203A, 203B, 204A, 204B, 205A and 205B, each of the plurality of zones defining one of a plurality of input locations and output locations. These two primary elements are necessary to generate the pick wave.

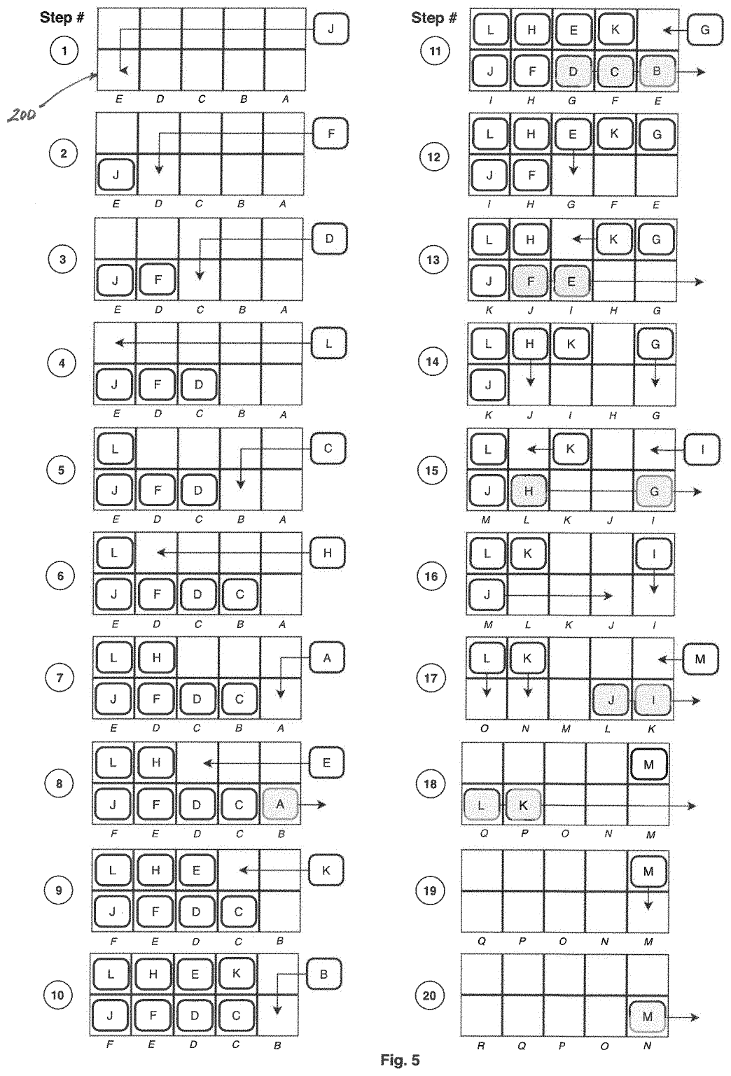

Referring now to FIGS. 4 and 5, an example is provided. FIG. 4 illustrates the item locations, the sorting apparatus configuration, the desired delivery sequence and the corresponding pick wave sequence as determined by the automated pick wave sequence generator system 100. FIG. 5 depicts the logical steps taken by the in-memory simulator to determine the pick wave sequence. A description of each logical step is provided below.

Step 1. Begin location evaluation for Item J entering the sorting apparatus 200. The delivery sequence of Item J does not match that of any of the available output locations. Item J must be transported to 205B to allow the maximum number of remaining transportation location options for incoming items.

Step 2. Begin location evaluation for Item F entering the sorting apparatus 200. The delivery sequence of item F does not match that of any of the available output locations. Item F has a delivery sequence less than Item J and must be transported to 204B to allow the maximum number of remaining transportation location options for incoming items.

Step 3. Begin location evaluation for Item D entering the sorting apparatus 200. The delivery sequence of Item D does not match that of any of the available output locations. Item D has a delivery sequence less than Item F and must be transported to 203B to allow the maximum number of remaining transportation location options for incoming items.

Step 4. Begin location evaluation for Item L entering the sorting apparatus 200. The delivery sequence of Item L does not match that of any of the available output locations. Item L has a delivery sequence greater than Item J. Item L must be transported to 205A to allow the maximum number of remaining transportation location options for incoming items.

Step 5. Begin location evaluation for Item C entering the sorting apparatus 200. The delivery sequence of Item C does not match that of any of the available output locations. Item C has a delivery sequence less than Item D and must be transported to 202B to allow the maximum number of remaining transportation location options for incoming items.

Step 6. Begin location evaluation for Item H entering the sorting apparatus. The delivery sequence of Item H does not match that of any of the available output locations. Item H has a delivery sequence greater than Item F. Item H must be transported to 204A to allow the maximum number of remaining transportation location options for incoming items.

Step 7. Begin location evaluation for Item A entering the sorting apparatus. Item A has a delivery sequence matching that of 201B and can be transported to that location.

Step 8. Begin location evaluation for Item E entering the sorting apparatus 200. The delivery sequence of Item E does not match that of any of the available output locations. Item E has a delivery sequence greater than Item D. Item E must be transported to 203A to allow the maximum number of remaining transportation location options for incoming items. Item A has delivery sequence matching that of 201B and may now exit the sorting apparatus 200. The delivery sequence for each output location is indexed by 1.

Step 9. Begin location evaluation for Item K entering the sorting apparatus 200. The delivery sequence of Item H does not match that of any of the available output locations. Item K has a delivery sequence greater than Item C. Item K must be transported to 202A to allow the maximum number of remaining transportation location options for incoming items.

Step 10. Begin location evaluation for Item B entering the sorting apparatus 200. Item B has a delivery sequence matching that of 201B and can be transported to that location.

Step 11. Begin location evaluation for Item G entering the sorting apparatus 200. Item G must wait at 201A as all other inbound locations are full. Items B, C, and D have a delivery sequence matching that of 201b, 202b, and 203b and may now exit the sorting apparatus 200. The delivery sequence for each output location is indexed by 3.

Step 12. Begin location evaluation for Item E at 203A. Item E has a matching delivery sequence equal to that of 201B and may now transport to location 203B.

Step 13. Begin location evaluation for Item K at 202A. Item K has a delivery sequence greater than Item E and must be transported to 203A to allow the maximum number of remaining transportation location options for incoming items. Item E and Item F have a delivery sequence matching that of 201b and 202b and may now exit the sorting apparatus 200. The delivery sequence for each output location is indexed by 2.

Step 14. Begin location evaluation for Item G entering the sorting apparatus 200 and Item H at 204A. Item G has a matching delivery sequence equal to 201b. Item G may now transport to 201B. Item H has a matching delivery sequence equal to 202B. Item H may now transport to 204B.

Step 15. Begin location evaluation for item K at 203a. Item K has a delivery sequence greater than 204b. Item K may now transport to 204a. Item G and item H have a delivery sequence matching that of 201b and 202b and may exit the sorting apparatus. The delivery sequence for each output location is indexed by 2. Item I is introduced to location 201a. Item I has a matching delivery sequence to 201b but must wait for Item G and Item H to exit the sorting apparatus.

Step 16. Begin location evaluation for Item I entering the sorting apparatus and Item J at 205B. Item I has a matching delivery sequence to 201B. Item I can now transport to 201B. Item J has a matching delivery sequence to 202B. Item J can now transport to 202B.

Step 17. Item I and Item J have matching delivery sequences to 201B and 202B, respectively, and may now exit the sorting apparatus 200. The delivery sequence for each output location is indexed by 2. Item K and Item L now have a matching delivery sequence to 201B and 202B. Item L may transport to 205B. Item K may transport to 204B. Begin location evaluation for Item M entering the sorting apparatus 200.

Step 18. Item K and Item L have matching delivery sequence to 201B and 202B. Item K and Item L may now exit the sorting apparatus 200. The delivery sequence for each location is indexed by 2. Item M now has a matching delivery sequence to 201b but must wait for Item K and Item L to exit the sorting apparatus 200.

Step 19. Item M has a matching delivery sequence to 201B and my now transport to 201B.

Step 20. Item M has a matching delivery sequence to 201B and may now exit the sorting apparatus 200. The delivery sequence for each exit location is indexed by 1.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

While the present invention has been shown and described in accordance with several preferred and practical embodiments, it is recognized that departures from the instant disclosure are contemplated within the spirit and scope of the present invention.

What is claimed is:

1. A computer-implemented method comprising:
under control of one or more computing systems configured with executable instructions, receiving a user input being defined as a delivery sequence list and an item location list;
detecting, with a conveyor system including a sorting apparatus, the sorting apparatus including a plurality of zones, each of the plurality of zones defining one of a plurality of input locations or output locations, a sorting apparatus configuration;
determining, based at least in part on the sorting apparatus configuration and the user input, a pick wave sequence list including a plurality of item information;
in response to determining the pick wave sequence list, sending for presentation to a user, first item information, wherein the first item information includes a representation of a first item determined to be associated with the user input for picking;
determining that the user has placed the picked item on one of the plurality of input locations of the sorting apparatus;
positioning the first item on one of the input and output locations of the plurality of zones in accordance with the delivery sequence list;
sending for presentation to a user, subsequent item information, wherein the subsequent item information includes a representation of a subsequent item determined to be associated with the user input for picking;
determining that the user has placed the picked item on one of the plurality of input locations of the sorting apparatus; and
positioning the subsequent item on one of the input and output locations of the plurality of zones in accordance with the delivery sequence list.

2. A computer-implemented method comprising:
under control of one or more computing systems configured with executable instructions, receiving a user input;
detecting, with a conveyor system including a sorting apparatus, the sorting apparatus including a plurality of zones, each of the plurality of zones defining one of a plurality of input locations or output locations, a sorting apparatus configuration;
determining, based at least in part on the sorting apparatus configuration and the user input, a pick wave sequence list including a plurality of item information;
in response to determining the pick wave sequence list, sending for presentation to a user, first item information, wherein the first item information includes a representation of a first item determined to be associated with the user input for picking;
determining that the user has placed the picked item on one of the plurality of input locations of the sorting apparatus;
positioning the first item on one of the input and output locations of the plurality of zones in accordance with the delivery sequence list;
sending for presentation to a user, subsequent item information, wherein the subsequent item information includes a representation of a subsequent item determined to be associated with the user input for picking;
determining that the user has placed the picked item on one of the plurality of input locations of the sorting apparatus; and
positioning the subsequent item on one of the input and output locations of the plurality of zones in accordance with the delivery sequence list.

3. The computer-implemented method as recited in claim 2 wherein the user input is a delivery sequence list.

4. The computer-implemented method as recited in claim 2 wherein the user input is an item location list.

5. A pick wave sequence system comprising:
a conveyor system including a sorting apparatus, the sorting apparatus including a plurality of zones, each of the plurality of zones defining one of a plurality of input locations or output locations;
a computing system including one or more processors; and
a database coupled to the one or more processors and storing program instructions that are executed by the one or more processors upon receipt of a user input defining a delivery sequence list and an item location list causing the one or more processors to at least determine, based at least in part on the sorting apparatus configuration and the user input, a pick wave sequence list.
